(19) United States
(12) Patent Application Publication
(10) Pub. No.: US 2004/0032410 A1
(43) Pub. Date: Feb. 19, 2004

(54) System and method for generating a structured two-dimensional virtual presentation from less than all of a three-dimensional virtual reality model

(76) Inventor: John Ryan, San Diego, CA (US)

Correspondence Address: MCDERMOTT, WILL & EMERY, Suite 500, 18191 Von Karman Ave., Irvine, CA, 92612-0187, US

(21) Appl. No.: 10/637,700

(22) Filed: Aug. 11, 2003

Related U.S. Application Data
(63) Continuation-in-part of application No. 10/434,386, filed on May 7, 2003.
(60) Provisional application No. 60/378,914, filed on May 9, 2002.

(51) Int. Cl. G06T 15/10

(52) U.S. Cl. 345/427; 345/473

(57) ABSTRACT

A system and method for generating a two-dimensional virtual presentation of image information using less than all panoramic scenes within a three-dimensional virtual reality space includes selecting a first location within the three-dimensional virtual reality space, storing data relating to a virtual reality panoramic scene at one or more scalar resolutions from the first location, selecting a second location within the three-dimensional virtual reality space, storing data relating to a virtual reality panoramic scene at one or more scalar resolutions from the second location, creating at least one route between the first and second locations, wherein the route entails linear image information at one or more scalar resolutions for movement between the first and second locations, storing the linear image information of the at least one route, and generating the two-dimensional virtual presentation of image information based on the selected locations within the three-dimensional virtual reality space and the at least one route connecting the selected locations.

### RELATED APPLICATION

The present application is a continuation-in-part of U.S. patent application Ser. No. 10/434,386, the subject matter of which is hereby incorporated by reference, which claims priority from Provisional Patent Application No. 60/378,914 filed May 9, 2002.

### FIELD OF THE INVENTION

The present invention relates generally to a method of generating virtual reality images, and, more particularly, to a method of generating a two-dimensional virtual presentation of image information using less than all panoramic scenes within a three-dimensional virtual reality space.

### BACKGROUND OF THE INVENTION

Virtual reality technologies and systems promise to revolutionize the art of human-computer interaction by offering new ways for the communication of information, the visualization of processes, and the creative expression of ideas. Applications of virtual reality include training in a variety of areas (military, medical, equipment operation, etc.), education, design prototyping and evaluation, architectural walk-through, investigation of molecular structures of complex molecules, computer-assisted surgery, assistance for the handicapped, study and treatment of phobias (e.g., fear of height), and entertainment.

In immersive virtual reality, the user becomes fully immersed in an artificial, three-dimensional world that is completely generated by a computer. The user is presented with an immersive visual experience by using various three-dimensional image presentation devices such as the head-mounted display (HMD), the binocular omni-orientation monitor (BOOM), or the cave automatic virtual environment (CAVE). A variety of input devices such as data gloves, joysticks, and hand-held wands allow the user to navigate through a virtual environment and to interact with virtual objects. Directional sound, tactile and force feedback devices, voice recognition and other technologies are being employed to enrich the immersive experience and to create more “sensualized” interfaces.

In non-immersive virtual reality, the user interacts with a three-dimensional environment presented on a graphics monitor by using a mouse, joystick, or other computer input devices. The Virtual Reality Modeling Language (VRML) and its successor Extensible 3D (X3D) provide non-immersive virtual reality presentation and interaction over the Internet, including the World Wide Web.

Whether immersive or not, it is the nature of virtual reality systems that they demand a very large amount of computing resources. Virtual reality systems require very high computing power in order to generate thousands of high resolution three-dimensional graphic elements “on the fly”, a large amount of volatile computer memory (RAM) to store and modify the three-dimensional visual information instantaneously so that the user can interact with the system “live”, and a large amount of storage space (hard disks) in order to store large amount of data that form the basis of virtual reality presentation and interaction. Typically, virtual reality systems run on high-end workstations, high performance servers and server farms, mainframes, or supercomputers.

Such high demand on computing resources places the virtual reality system beyond the reach of most end users. The network-based virtual reality systems such as the systems utilizing VRML and X3D are not realistic alternatives yet due to the high bandwidth requirement for such applications. Although the personal computers are becoming more powerful and the broadband Internet is becoming more widely available, practical virtual reality systems are not likely to be feasible on end user computers or devices in a near future. This is especially true for virtual reality representation of large or complex structures such as a mountain or a complex protein with millions of subparts.

However, it is frequently the case that users are not interested in exploring all of the virtual reality space from all possible views. For a number of practical reasons, users may be interested in a limited set, a subset, or less than all of a given virtual reality space. Furthermore, in some circumstances, it may be possible to predict or predetermine the subset that the users would be interested in. In such situations, a large amount of computing resources required to support the entirety of the virtual space may not be necessary. For an artfully defined subset, it may in fact be possible to support the subset on personal computers, laptops, or even hand-held devices such as the PDAs.

Currently available virtual reality systems, however, do not provide a convenient method of defining a subset of interest in a given virtual reality space. Many virtual reality systems allow the capture of “fly-through” into a file that can later be played back. The utility of this method of subset capture is severely limited in presenting an overall virtual reality experience, because the user cannot interact with the rest of the virtual reality environment.

Method of defining a subset in a given virtual reality space is also related to updating and improving the virtual reality model when the model is a representation of a real world object such as a terrain of a geographical area. For such systems, the best way to update, correct, or improve a virtual reality model is to compare it directly with the real objects that are modeled. However, the direct comparison in the field or on site is essentially impractical with the currently available virtual reality systems because carrying around the high power workstations and mainframes in the field is not practical in most cases.

Thus, it can also be seen that there is a need in the art for a system and method for presenting an overall virtual reality experience on field-portable computers such as laptops and PDAs such that the virtual reality model can be conveniently compared to the physical reality in the field or on site and update, corrections, and improvement can be effectively made.

It can be seen, then, there is a need for conveniently defining and capturing a subset or less than all of a given virtual reality space such that an overall virtual reality experience can be presented on personal computers, laptops, and PDAs that are available to millions of users. The present invention satisfies this need and provides related advantages as well.

### SUMMARY OF THE INVENTION

The present invention addresses the needs in the art by providing a method for defining and capturing a subset (less than all) of a given virtual reality space and generating a two-dimensional virtual presentation of the captured of image information such that an overall virtual reality experience can be presented on personal computers, laptops, and PDAs that are available to millions of users.

The method centers on a network of nodes and routes that builds a quasi-three-dimensional framework. The nodes, or nodal points, are virtual reality panoramic scenes of a fixed point within the virtual reality space generated at multiple scalar resolutions. The routes entail linear route knowledge provided by multiple scalar resolutions movement between nodal points. A subset of interest within a given virtual reality space is defined by determining the nodes, routes, and their interconnections.

A subset is captured by utilizing a three-dimensional virtual reality system. For example, in a fully immersive virtual reality system, the operator explores the virtual world, selects a scene of interest and designates it as a nodal point with data gloves. The operator navigates through the virtual environment to another nodal point and defines a route between the two nodes. In a non-immersive system, the operator may interact with the virtual reality model with a mouse, defining nodes and tracing routes. When the defined network of notes and routes is saved, the system generates two-dimensional virtual presentation image information comprising virtual reality panoramic scenes of the nodal points at multiple scalar resolutions and linear image information of routes at multiple scalar for movement between the nodal points. The generated information can be saved in a file or files for persistent storage and download to user or field computers.

The generated files containing two-dimensional presentation are much smaller in size than comparable files for three dimensional virtual reality so that the two dimensional files can be accommodated by personal computers, laptops, and PDAs. In addition, the information regarding the network of nodes and routes, representing the overall view of the virtual reality world, is presented to users on field usable computers. The users can then operate the system on their computers to experience the subset of virtual reality.

For virtual reality models representing physical reality objects, the users can then compare the virtual model directly with the physical reality in the field or on site, using the two-dimensional representation system on their field-portable computers. The field images of the physical objects can be captured to replace or improve the two-dimensional presentation on the field computers, or to correct, update, or improve the three-dimensional virtual reality system residing in the more powerful workstations, servers, mainframes, or supercomputers.

For virtual reality models representing geographical physical reality objects, the present invention can include the Global Positioning System (GPS) information so that the geographical objects can be accurately and conveniently located and matched to the virtual reality model. Using the GPS information, the users can accurately capture the images of the physical objects to replace or update the two-dimensional virtual presentation on their computers. In addition, The field captured images can be used to correct, update, or improve the three-dimensional virtual reality model residing in the more powerful workstations, servers, mainframes, or supercomputers.

According to one embodiment, the present invention is a system for generating a two-dimensional virtual presentation of image information using less than all panoramic scenes within a three-dimensional virtual reality model. The apparatus includes a central computer, a virtual reality display device connected to the central computer for displaying a three-dimensional virtual reality model to an operator, a virtual reality input device connected to the central computer for processing operator input so that the operator can navigate, control, and otherwise interact with the three-dimensional virtual reality model, and a storage device connected to the central computer for storing data, wherein the central computer processes a command input from the virtual reality input device 1) for selecting a first location within the three-dimensional virtual reality model, 2) for storing data in the storage device relating to a virtual reality panoramic scene at one or more scalar resolutions from the first location, 3) for selecting a second location within the three-dimensional virtual reality model, 4) for storing data in the storage device relating to a virtual reality panoramic scene at one or more scalar resolutions from the second location, 5) for creating at least one route between the first and second locations, wherein the route entails linear image information at one or more scalar resolutions for movement between the first and second locations, 6) for storing the linear image information of the at least one route, and 7) for generating the two-dimensional virtual presentation of image information based on the selected locations within the three-dimensional virtual reality model and the at least one route connecting the selected locations.

According to another embodiment, the present invention is a method for generating a two-dimensional virtual presentation of image information using less than all panoramic scenes within a three-dimensional virtual reality space including selecting a first location within the three-dimensional virtual reality space, storing data relating to a virtual reality panoramic scene at one or more scalar resolutions from the first location, selecting a second location within the three-dimensional virtual reality space, storing data relating to a virtual reality panoramic scene at one or more scalar resolutions from the second location, creating at least one route between the first and second locations, wherein the route entails linear image information at one or more scalar resolutions for movement between the first and second locations, storing the linear image information of the at least one route, and generating the two-dimensional virtual presentation of image information based on the selected locations within the three-dimensional virtual reality space and the at least one route connecting the selected locations.

According to another embodiment, the present invention is computer-executable process steps for generating a two-dimensional virtual presentation of image information using less than all panoramic scenes within a three-dimensional virtual reality space, wherein the process steps are stored on a computer-readable medium, including a step for selecting a first location within the three-dimensional virtual reality space, a step for storing data relating to a virtual reality panoramic scene at one or more scalar resolutions from the first location, a step for selecting a second location within the three-dimensional virtual reality space, a step for storing data relating to a virtual reality panoramic scene at one or more scalar resolutions from the second location, a step for creating at least one route between the first and second locations, wherein the route entails linear image information at one or more scalar resolutions for movement between the first and second locations, a step for storing the linear image information of the at least one route, and a step for generating the two-dimensional virtual presentation of image information based on the selected locations within the three-dimensional virtual reality space and the at least one route connecting the selected locations.

The brief summary has been provided so that the nature of the invention may be understood quickly. A more complete understanding of the invention can be obtained by reference to the following detailed description of the embodiment(s) thereof in connection with the attached drawings.

### BRIEF DESCRIPTION OF THE DRAWINGS

Referring now to the drawings in which like reference numbers represent corresponding parts throughout:

FIG. 1 illustrates an outward view of a hardware environment embodying the present invention;

FIG. 2 illustrates an internal systems view of a computing environment embodying the present invention;

FIG. 3 illustrates a representation of a three-dimensional virtual reality space;

FIG. 4 illustrates an embodiment of defining and capturing of a subset or less than all of a three-dimensional virtual reality space;

FIG. 5 illustrates an embodiment of a network of nodes and routes representing a subset or less than all of a three-dimensional virtual reality space; and

FIG. 6 illustrates a flowchart in accordance with the present invention.

In the following description of the invention, reference is made to the above-noted drawings that form a part thereof, and in which is shown by way of illustration a specific embodiment in which the invention may be practiced. It is to be understood that other embodiments may be utilized and changes may be made without departing from the scope of the present invention.

### DETAILED DESCRIPTION OF THE INVENTION

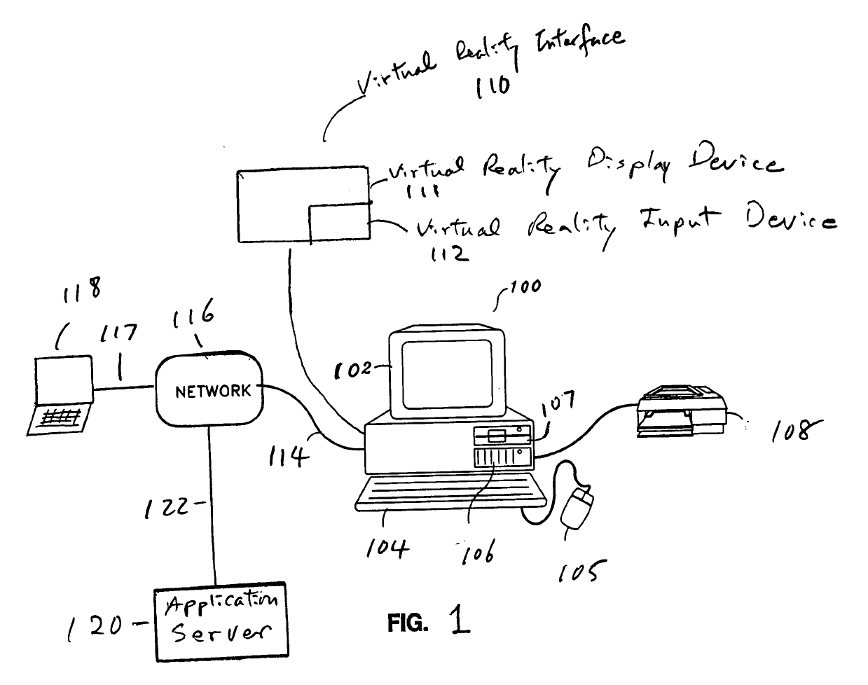

FIG. 1 illustrates an outward view of a hardware environment embodying the present invention. As shown in FIG. 1, the hardware environment can include central computer 100, display monitor 102, keyboard 104, mouse 105, fixed disk drive 106, removable disk drive 107, hardcopy output device 108, virtual reality interface 110, virtual reality display device 111, virtual reality input device 112, computer network connection 114, computer network 116, computer network connection 117, field computer 118, and application server 120.

Central computer 100 can be a workstation, a server, a mainframe, or a supercomputer without departing from the scope of the present invention. Central computer 100 has sufficient computing power to generate a large number of high resolution three-dimensional graphic elements “on the fly” and a sufficient amount of volatile computer memory (RAM) to store and modify the three-dimensional visual information instantaneously so that the user can interact with the system “live”. Central computer 100 can comprise more than one computer or computing units without departing from the scope of the present invention. Central computer 100 can be a server farm that comprises multiple graphics servers or a supercomputer that comprises a variable number of scalable computing units.

Display monitor 102 displays the graphics, images, and texts that comprise the user interface for the virtual reality application as well as the operating system programs necessary to operate the computer. For a non-immersive virtual reality system, display monitor 102 can also serve as the visual display device for the three-dimensional images that comprise visual experience of virtual reality.

An operator of central computer 100 uses keyboard 104 or other input device to enter commands and texts to operate and control the computer operating system programs as well as the application programs including the virtual reality application. The operator uses mouse 105 to select and manipulate graphics and text objects displayed on display monitor 102 as part of the interaction with and control of the central computer 100 and applications running the computer. Mouse 105 can be any type of pointing device, including a joystick, a trackball, or a touch-pad without departing from the scope of the present invention. For a non-immersive virtual reality system, keyboard 104 and mouse 105 can also serve as the input devices to navigate the virtual reality world and control objects in the virtual reality space.

Fixed disk drive 106 provides sufficient amount of storage space in order to store large amount of data that form the basis of virtual reality presentation and interaction. Fixed disk drive 106 can comprise a number of physical drive units without departing from the scope of the present invention. Fixed disk drive 106 can also be a disk drive farm or a disk array that can be physically located in a separate computing unit without departing from the scope of the present invention. Removable disk drive 107 is a removable storage device that can be used to off-load data from central computer 100 or upload data onto central computer 100. Without departing from the scope of the present invention, removable disk drive 107 can be a floppy disk drive, an Iomega Zip drive, a CD-ROM drive, a CD-Recordable drive (CD-R), a CD-Rewritable drive (CD-RW), a DVD-ROM drive, or any one of the various recordable or rewritable DVD drives such as the DVD-R, DVD-RW, DVD-RAM, DVD+R, or DVD+RW. Operating system programs, applications, and various data files are stored on disks. The files can be stored on fixed disk drive 106 or on a removable media for removable disk drive 107 without departing from the scope of the present invention.

Hardcopy output device 108 provides an output function for the operating system programs and applications including the virtual reality application. Hardcopy output device 108 can be a printer or any output device that produces tangible output objects without departing from the scope of the present invention.

Virtual reality interface 110 comprises virtual reality display device 111 and virtual reality input device 112. Virtual reality interface 110 can present immersive or non-immersive virtual reality without departing from the scope of the present invention. In immersive virtual reality, the user becomes fully immersed in an artificial, three-dimensional world that is constructed by central computer 100. For a presentation of an immersive visual experience, virtual reality display device 111 can be a head-mounted display (HMD), a binocular omni-orientation monitor (BOOM), or a cave automatic virtual environment (CAVE) without departing from the scope of the present invention. For a non-immersive or partially immersive experience, virtual reality display device 111 can be a stereoscopic display device, a stereo projection system, a display monitor viewed with stereo glasses, or ordinary graphics display monitor, without departing from the scope of the present invention. It should also be noted that the boundaries between immersive and non-immersive virtual reality systems are becoming blurred due to advances in technology. The technical distinction between immersive and non-immersive systems discussed here is not meant to limit or confine the scope of the present invention in any way.

Virtual reality input device 112 can be a data glove, a hand-held wand, a three-dimensional joystick, a three-dimensional mouse, a joystick, or a mouse without departing from the scope of the present invention. Virtual reality input device 112 allows the user to navigate through a virtual environment and to interact with virtual objects. Tactile and force feedback devices (sometimes called haptic interface devices) as well as directional sound can be incorporated to enrich the immersive experience and to create more “sensualized” interfaces.

Computer network 116 is a network over which central computer 100 can communicate with other computers or systems, including field computer 118. Computer network 116 can be a local area network, an intranet, a wide-area network, or the Internet without departing from the scope of the present invention. Central computer 100 can be connected to computer network 116 via computer network connection 114.

Field computer 118 can be a personal computer, a laptop, or a handheld computing device including a PDA, without departing from the scope of the present invention. Because field computer 118 can have the characteristics of a general purpose computer, field computer 118, like central computer 100, can be equipped with a display monitor, a fixed disk drive, a removable disk drive, a keyboard, a pointing device, and a hardcopy output device, without departing from the scope of the present invention. Field computer 118 can be connected to computer network 116 by computer network connection 117.

Application server 120 can be any computer with sufficient computing resources and storage capacity to store the two-dimensional virtual reality files generated by central computer 100. Application server 120 can comprise multiple computers without departing from the scope of the present invention. Application server 120 is connected to computer network 116 by computer network connection 122 such that central computer 100 and field computer 118 can store and retrieve files on application server 120 over the network.

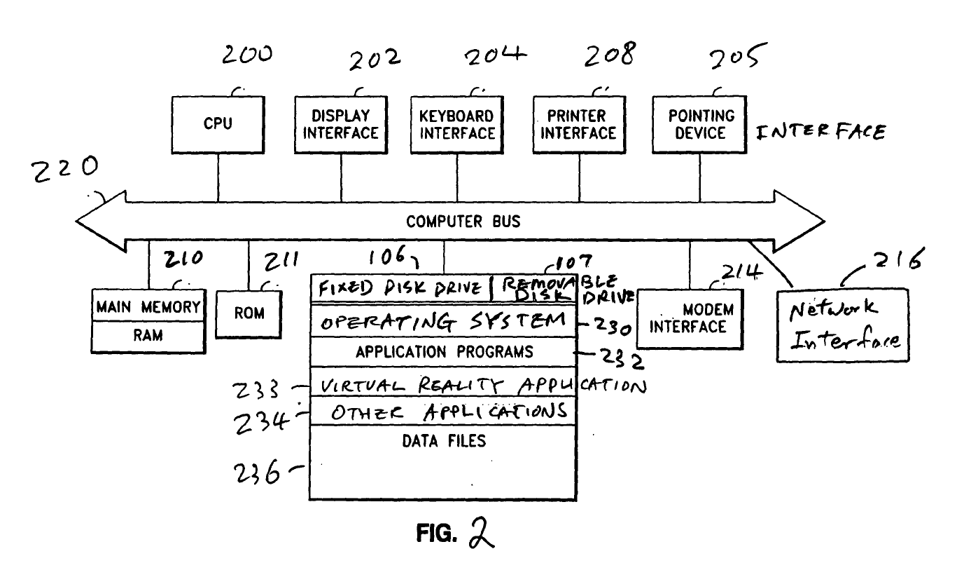

FIG. 2 illustrates an internal systems view of a computing environment embodying the present invention. As shown in FIG. 2, the computing environment can include: CPU 200 where the computer instructions that comprise an operating system or an application, including a virtual reality application, are processed; display interface 202 which provides communication interface and processing functions for rendering graphics, images, and texts on display monitor 102; keyboard interface 204 which provides a communication interface to keyboard 104; pointing device interface 205 which provides a communication interface to mouse 105 or an equivalent pointing device; printer interface 208 which provides a communication interface to hardcopy output device 108; RAM 210 where computer instructions and data can be stored in a volatile memory device for processing by CPU 200; ROM 211 where low-level systems code or data are stored in a non-volatile memory device; fixed disk drive 106 and removable disk drive 107 where the files that comprise operating system 230, application programs 232 (including virtual reality application 233 and other applications 234) and data files 236 are stored; modem interface 214 which provides a communication interface to computer network 116 over a modem connection; and computer network interface 216 which provides a communication interface to computer network 116 over a computer network connection. The constituent devices and CPU 200 communicate with each other over computer bus 220.

For central computer 100, CPU 200 can be any of the high-performance CPUs, including an Intel CPU, a PowerPC CPU, a MIPS RISC CPU, a SPARC CPU, or a proprietary CPU for a mainframe or a supercomputer, without departing from the scope of the present invention. CPU 200 in central computer 100 can comprise more than one processing units, including a multiple CPU configuration found in high-performance workstations and server, or a multiple scalable processing units found in mainframes or supercomputers. For field computer 118, CPU 200 can be any one of the CPUs used in personal computers, laptops, or handheld computers, including an Intel CPU, a PowerPC CPU, an XScale CPU, or an ARM CPU, without departing from the scope of the present invention.

For central computer 100, operating system 230 can be: Windows NT/2000/XP Workstation; Windows NT/2000/XP Server; a variety of Unixflavor operating systems, including Irix for SGI workstations and supercomputers, SunOS for Sun workstations and servers, Linux for Intel CPU-based workstations and servers, HP-UX for HP workstations and servers, AIX for IBM workstations and servers, Mac OS X for PowerPC based workstations and servers; or a proprietary operating system for mainframes or supercomputers. For field computer 118, operating system 230 for a personal computer or a laptop can be Windows 95, Windows 98, Windows Me, or Windows NT/2000/XP Workstation. For handheld devices, operating system 230 can be PalmOS, Windows CE, Windows Embedded, or Pocket PC.

The present invention provides a method and system for defining and capturing a subset or less than all of a given virtual reality space in a three-dimensional virtual reality environment, and generating a two-dimensional virtual presentation of the captured image information such that an overall virtual reality experience can be presented on personal computers, laptops, and handheld devices that are available to millions of users.

The present invention builds a quasi-three-dimensional framework from a network of nodes and routes. The nodes, or nodal points, are virtual reality panoramic scenes of a fixed point within the virtual reality space generated at multiple scalar resolutions. The routes entail linear route knowledge provided by multiple scalar resolutions movement between nodal points. A subset of interest within a given virtual reality space is defined by determining the nodes, routes, and their interconnections. The nodes are alternatively called the ‘hubs’, and the routes the ‘spokes’. A given virtual reality space in a three-dimensional virtual reality environment is sometimes referred to as a virtual reality model without departing from the scope of the present invention.

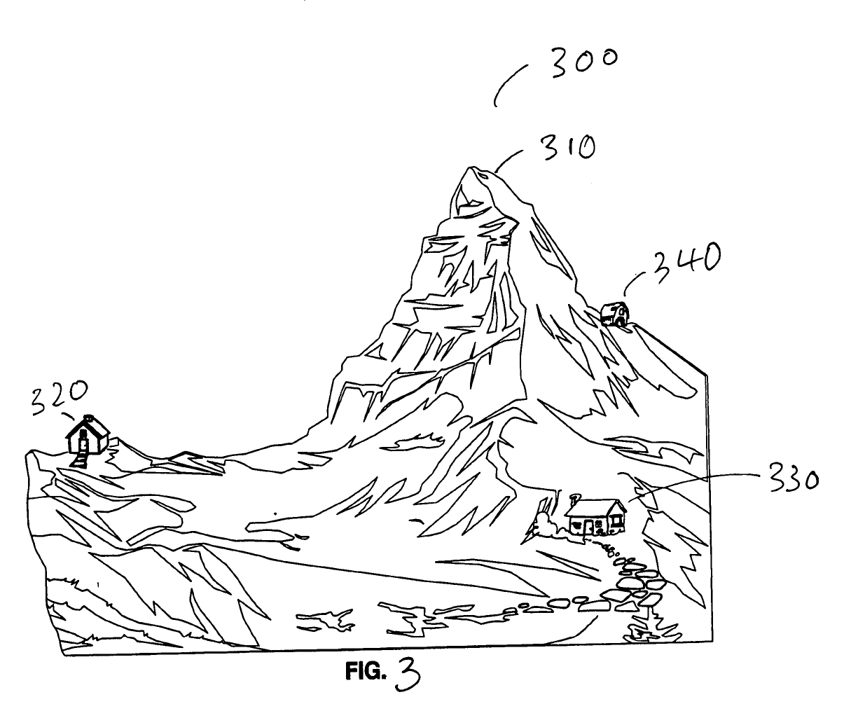

The method and system of the present invention begins with a three-dimensional virtual reality environment. FIG. 3 illustrates a representation of a three-dimensional virtual reality space of a mountainous terrain. Virtual reality space 300 is shown in FIG. 3 as a mountainous terrain comprising peak 310, cabin 320, cabin 330, cabin 340 and the surrounding areas. An artificial, three-dimensional world of virtual reality space 300 is constructed by central computer 100 from graphics generation specifications and accompanying files, including image files. Constructed virtual reality space 300 is presented to an operator by virtual reality display device 111. The operator explores virtual reality space 300 by navigating and interacting with the environment by utilizing virtual reality display device 111 and virtual reality input device 112. The operator then determines a subset or less than all of virtual reality space 300 based on the points and areas of interest to the operator.

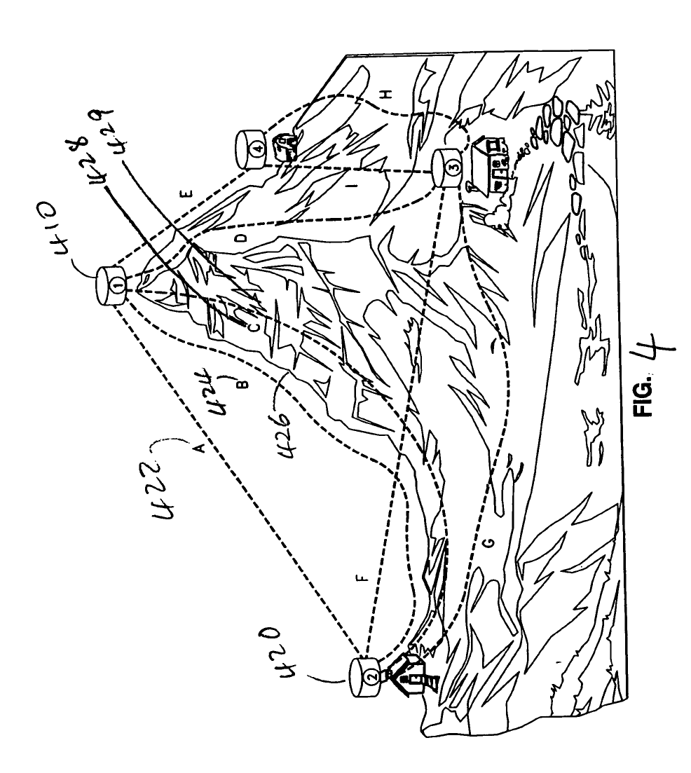

FIG. 4 illustrates an embodiment of defining and capturing of a subset or less than all of a three-dimensional virtual reality space of a mountainous terrain. For example, in a fully immersive virtual reality system, an operator explores the virtual reality space 300 using a stereo projection system and a data glove, and comes upon peak 310. The operator determines that panoramic scene of peak 310 should be of interest to users and designates peak 310 as Node 1 (410) using the data glove. The operator then navigates through the virtual environment down the mountain to cabin 320, and designates cabin 320 as Node 2 (420). The operator defines Route A (422) as a direct “fly-through” route between Node 1 (410) and Node 2 (420), and Route B (424) as a “terrain following” route between the two nodes where the user view (sometimes called the avatar) is fixed at a distance above the ground, traveling along hillside 426 while “hugging” the contour of the terrain. Yet another route between Node 1 (410) and Node 2 (420) is defined as Route C (428) as a “terrain following” route along hillside 429. Remaining nodes and routes shown in FIG. 4—Nodes 3 and 4, Routes D, E, F, G, H, and I—are defined in a similar fashion. The selected nodes and routes capture the subset of interest within virtual reality space 300.

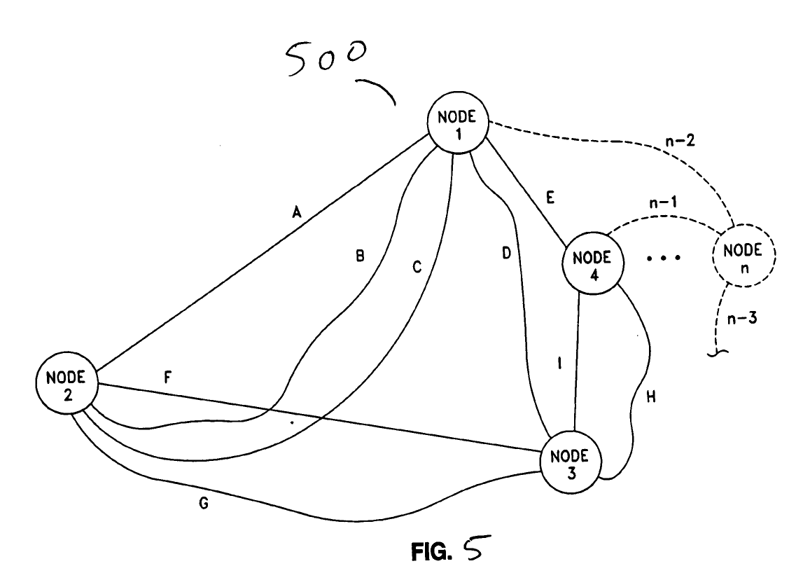

FIG. 5 illustrates an embodiment of a network of nodes and routes representing the subset or less than all of virtual reality space defined and captured as illustrated above. Network 500 comprises the nodes and routes defined in the above process. It should be noted that the term “network” is used here to mean something different from a computer network without departing from the scope of the present invention. It should also be noted that the term “node” is used in the present invention to mean something different from nodes in hierarchical scene graphs in computer graphics theory without departing from the scope of the present invention. A hierarchical scene graph is a data structure used to hold the elements needed to render a scene. The elements are called “nodes” in VRML and Java3d standards. They are referred to as “elements” in XML. Nodes in scene graphs contain information such as shape, light, or view angle that can be used to render a single graphical object. In contrast, a node in the present invention represents a fixed point in a three-dimensional virtual reality space where the virtual reality panoramic scene of the points is captured at multiple scalar resolutions. The term “route” is also used in the present invention to mean something different from routes in computer graphics theory without departing from the scope of the present invention. In the VRML and X3D specifications, a route is defined as the connection between a node generating an event and a node receiving the event. On the other hand, a route in the present invention represents a linear trail between two fixed points, i.e., the nodes, in a three-dimensional virtual reality space captured at multiple scalar resolutions.

Once a subset or less than all of a virtual reality space is defined and captured as a network of nodes and routes, the operator can save the information and command the system to generate two-dimensional virtual presentation image information comprising virtual reality panoramic scenes of the nodal points at multiple scalar resolutions and linear image information of routes at multiple scalar for movement between the nodal points. The generated information can be saved in a file or files for persistent storage and for download to field computer 118. The generated files for a given node or route contain a pointer or pointers to the next file or files to be loaded to present the next route or the panoramic scene of the next node. The generated files containing two-dimensional presentation are much smaller in size than comparable files for three dimensional virtual reality so that the two dimensional files can be accommodated by personal computers, laptops, and handheld devices. The files can be downloaded to field computer 118 over computer network 116 or by utilizing a removable media which can be a Zip disk, a compact disc (CD), or a DVD, without departing from the scope of the present invention. The two-dimensional information files can also be saved on application server 120 over computer network 116 such that the files can be accessed from field computer 118.

When using the present invention on field computer 118, typically the panoramic scene of node 1 is presented to the user. Alternatively, an overall view of the virtual reality world can be presented to the user, utilizing the information regarding the network of nodes and routes contained in the files downloaded from central computer 100 or from application server 120. The nodes and routes information can be made available to the user by presenting an outline of the network of nodes and routes superimposed on the overview of the scenes, as illustrated in FIG. 4. The user then can select a node to start the virtual reality exploration, where upon the panoramic scene of the selected node is presented to the user by loading files from a local disk or a removable disk, or from central computer 100 or application server 120 over network 116.

While exploring the panoramic scene of a given node, when the user places the cursor on the display screen of field computer 118 within an active area, hot spot or window of the node, or by an equivalent method thereof, the system takes the user to the next node through the route connected to the active area or window by loading into memory the files that contain the linear route movement information between the nodes at a scalar resolution selected by the user. There may be multiple active areas, hot spots, or windows within a given panoramic scene. The active area, hot spot or window may not be noticeable to the user, allowing seamless presentation of panoramic scene and routes. The user then can explore the virtual reality world by viewing the panoramic scene at the chosen scalar resolution and navigating to other nodes by invoking the defined routes between the nodes. An overall virtual reality experience is thus made possible on personal computers, laptops, and handheld devices that are available to millions of ordinary users.

As discussed above, the files containing two-dimensional virtual presentation image information of nodes and routes can be loaded from application server 120 over network 116. Such loading or accessing of the files can take place over the Internet without departing from the scope of the present invention. When accessing the files over the World Wide Web, or by utilizing the Hypertext Transfer Protocol (HTTP) over the Internet, the nodes and routes can point to or reference the relevant file or files via Uniform Resource Locators (URLs). Such networked approach would decrease or lessen the hardware requirements on field computer 118 even further, making it possible, for instance, to present a quasi-virtual reality experience of a very large or complex structure on computers with limited resources such as handheld devices including PDAs. Since the necessary files are loaded over the network as they are needed, there is no need to load the entire set of files onto field computer 118 in advance.

Application server 120 can comprise multiple computers without departing from the scope of the present invention. In some cases, field computer 118 can also serve as application server 120. In order to facilitate location and access of files on application server 120, directory information of the files may be compiled and updated. Such compilation of directory information can employ peer-to-peer protocols without departing from the scope of the present invention.

For virtual reality models representing physical reality objects, the users can compare the virtual model directly with the physical reality in the field or on site, using the two-dimensional representation system on field computer 118. The users can capture the field images of the physical objects to replace or to improve the two-dimensional virtual presentation on field computer 118. A video device such as a digital video camera can be used to capture the panoramic scenes within a node or the linear movement video images for a route. The captured video image files can be used to replace the two-dimensional presentation files (nodes or routes) or to supplement the file stored in the two-dimensional presentation on field computer 118.

In addition, the captured field images can be used to correct, update, or improve the three-dimensional virtual reality model residing in central computer 100. The correction, update, or improvement information can be uploaded from field computer 118 over computer network 116 or on a removable disk media. Thus, the present invention provides a method of capturing three-dimensional virtual reality information through the choices of nodes, routes, and their overviews which are structured together to increase or enhance information and knowledge of the operator of central computer 100 which can in turn be shared with all of the users of the system that comprises the present invention.

For virtual reality models representing geographical physical reality objects, the present invention can include the Global Positioning System (GPS) information so that the geographical objects can be accurately and conveniently located and matched to the virtual reality model. The GPS information can be included in the three-dimensional virtual reality model in central computer 100, and transferred to or embedded in the two-dimensional information generated for the selected nodes and routes. Using the GPS data at field, the geographical objects corresponding to the virtual reality objects can be conveniently and accurately located. The user can then capture the images of the geographical objects to replace or improve the two-dimensional virtual presentation on field computer 118. A video device such as a digital video camera can be used to capture the panoramic scenes of a node or the linear movement video images for a route. The captured video image files can be used to replace the two-dimensional presentation files or to overlay the two-dimensional presentation on field computer 118 as discussed above.

The capturing of physical reality images of the geographical objects at the field can also include the GPS data in the file along with the image information so that the three-dimensional virtual reality model residing in central computer 100 can be matched with the physical reality data from the field with accuracy and precision of the GPS system, allowing convenient and accurate correction, update, or improvement of the virtual reality model.

At central computer 100, the present invention can be implemented as a software package that is an extension to a high-end three-dimensional virtual reality display program without departing from the scope of the present invention. The software package can comprise a set of graphical user interface and menu hierarchy of commands, where the commands can include: a software button or menu entry to activate the capture of a node or a nodal point in a three-dimensional virtual reality space; and a software button or menu entry to activate the capture of a route to the next node and store the route in a three-dimensional virtual reality space. The commands can further include a dropdown menu that gives: a command to automatically capture the routes between all nodes previously defined and captured in a scene; a command to redraw the scene captured in a network of nodes and routes; a command to edit a network of nodes and routes; a command to highlight the best route; a command to capture the image information of a network of nodes and routes, and generate two-dimensional image files at a selected resolution or resolutions; and a command to import and embed field acquired physical reality images into the associated nodes and routes, overriding or overlaying the computer-generated version at the defined scalar resolution. The command to capture image information and generate two-dimensional files can include a dropdown menu that further gives subcommands for: a command to capture at a resolution depicted by icons that represent or symbolize various scalar resolutions, such as icons depicting satellite, high altitude aircraft, bird, binoculars, magnifying glass, and pick'n shovel; a command to capture at all resolutions; and a command to customize each resolution. The satellite icon represents or symbolizes the scalar resolution at a highest point of view, such as a view from a satellite. The remaining icons represent or symbolize resolutions at successively lower point of view. The pick'n shovel icon represents a subterranean walk-through or fly-through.

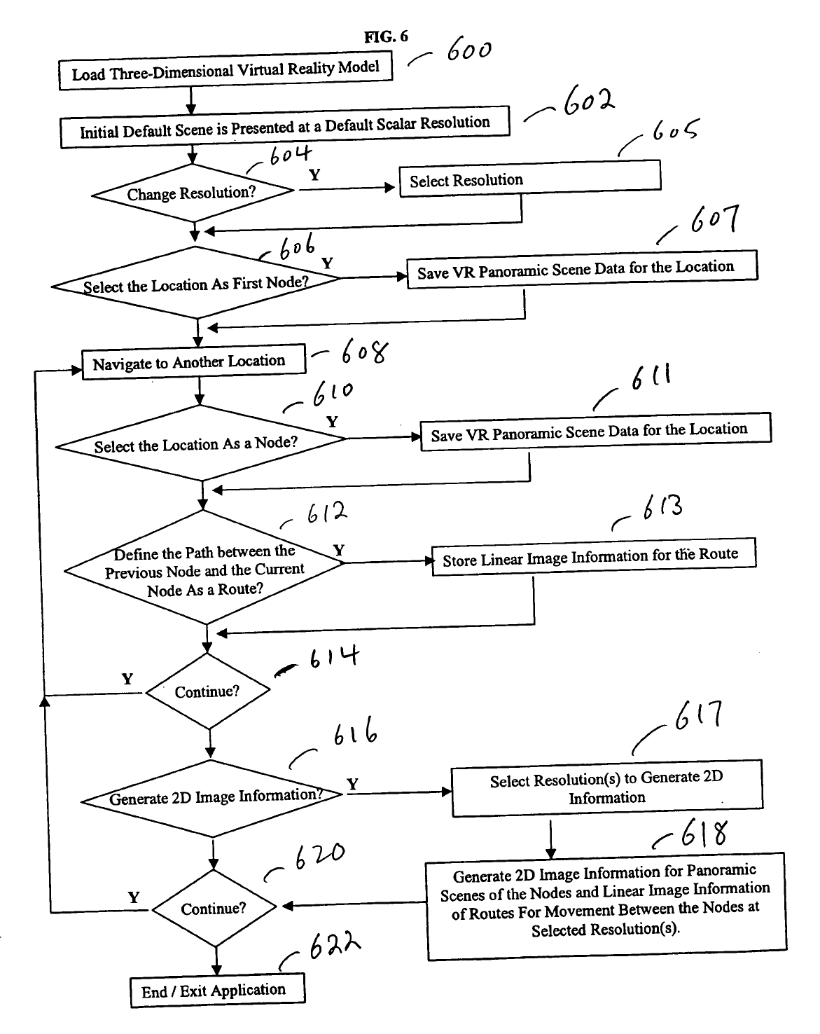

FIG. 6 illustrates a flowchart in accordance with the present invention.

To start, a three-dimensional virtual reality model is loaded in central computer 100 (Step 600). The operator is presented with a default initial scene at a default initial resolution (Step 602). The operator then has the option to change the scalar resolution at which to explore the virtual reality world (Step 604). Step 605 illustrates selecting a resolution.

The operator may select the location as the first node or node 1 (Step 606) or navigate to another location (Step 608) within the virtual reality space. When the operator selects the location as node 1, the virtual reality image data relating to panoramic scenes of the location is saved (Step 607).

When the operators navigates to another location, the operator can select the arrived location as another node (Step 610), whereupon the virtual reality image data relating to panoramic scenes of the location is saved (Step 611).

The operator then has the option to define the path between the previous node and the current node as a route (Step 612). When a route has been defined, linear image information for the route is saved (Step 613). The operator can continue this process (Step 614), defining more nodes and routes until the operator is satisfied with the scenes selected.

Alternatively, the operator can generate the two-dimensional virtual presentation of image information for the nodes and routes (Step 616) as they are being selected. The operator can select the scalar resolution or resolutions at which the two-dimensional generation is to be done, including all supported resolutions (Step 617). Then, the two-dimensional image information is generated for panoramic scenes of the nodes and linear image information of routes for movement between the nodes at selected resolution or resolutions (Step 618).

If the operator had saved only the nodes and routes information without generating the two-dimensional information, generation of two-dimensional information can be done all at once through the steps 616, 617, and 618.

The operator may continue with the whole process (Step 620) until the operator is satisfied with the scenes selected and the desired two-dimensional information has been generated. Alternatively, the operator can end the session by exiting the three-dimensional virtual reality application (Step 622).

The foregoing description of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

What is claimed is:

1. An apparatus for generating a two-dimensional virtual presentation of image information using less than all panoramic scenes within a three-dimensional virtual reality model, the apparatus comprising:
means for presenting the three-dimensional virtual reality model to an operator;
means for processing operator input so that the operator can navigate, control, and otherwise interact with the three-dimensional virtual reality model;
means for selecting a first location within the three-dimensional virtual reality model;
means for storing data relating to a virtual reality panoramic scene at one or more scalar resolutions from the first location;
means for selecting a second location within the three-dimensional virtual reality model;
means for storing data relating to a virtual reality panoramic scene at one or more scalar resolutions from the second location;
means for creating at least one route between the first and second locations, wherein the route entails linear image information at one or more scalar resolutions for movement between the first and second locations;
means for storing the linear image information of the at least one route; and
means for generating the two-dimensional virtual presentation of image information based on the selected locations within the three-dimensional virtual reality model and the at least one route connecting the selected locations.

2. The apparatus of claim 1 further comprising means for transferring the two-dimensional virtual presentation of image information to a field location, and means for accessing and viewing the two-dimensional virtual presentation of image information at the field location.

3. The apparatus of claim 2 wherein transferring the two-dimensional virtual presentation of image information to the field location and accessing the two-dimensional virtual presentation of image information at the field location are conducted over a computer network.

4. The apparatus of claim 3 wherein the two-dimensional virtual presentation of image information is stored at one or more application servers on the computer network such that transferring the two-dimensional virtual presentation of image information to the field location and accessing the two-dimensional virtual presentation of image information at the field location are conducted over the computer network via the application servers.

5. The apparatus of claim 4 wherein the two-dimensional virtual presentation of image information is conducted over the Internet.

6. The apparatus of claim 5 wherein the two-dimensional virtual presentation of image information is located and accessed by Uniform Resource Locators (URLs).

7. The apparatus of claim 6 wherein directory information of the two-dimensional virtual presentation of image information, the application servers, and the URLs are automatically generated and updated.

8. The apparatus of claim 7 wherein the directory information is automatically generated and updated via a peer-to-peer protocol.

9. The apparatus of claim 2 wherein transferring the two-dimensional virtual presentation of image information to the field location and accessing the two-dimensional virtual presentation of image information at the field location are accomplished via a removable disk media.

10. The apparatus of claim 2 wherein the three-dimensional virtual reality model is a representation of objects existing in physical reality.

11. The apparatus of claim 10 further comprising means for capturing images and data of the objects existing in physical reality, and means for supplanting the two-dimensional virtual presentation of image information at the field location with the captured images and data.

12. The apparatus of claim 11 wherein a video device is utilized to capture panoramic scenes of locations and linear images of routes, and the captured images supplant files comprising the two-dimensional virtual presentation of image information.

13. The apparatus of claim 10 further comprising means for capturing images and data of the objects existing in physical reality, and means for overlaying the two-dimensional virtual presentation of image information at the field location with the captured images and data.

14. The apparatus of claim 13 wherein a video device is utilized to capture panoramic scenes of locations and linear images of routes, and the captured images are overlaid on the two-dimensional virtual presentation of image information.

15. The apparatus of claim 10 further comprising means for capturing images and data of the objects existing in physical reality, and means for correcting, updating, and improving the three-dimensional virtual reality model with the captured images and data.

16. The apparatus of claim 10 wherein the three-dimensional virtual reality model is a representation of geographical objects existing in physical reality.

17. The apparatus of claim 16 further comprising means for including Global Positioning System (GPS) information in the three-dimensional virtual reality model and the two-dimensional virtual presentation of image information, means for locating the geographical objects existing in physical reality using the GPS information, means for capturing images and data of the geographical objects existing in physical reality using the GPS information, and means for replacing or supplanting the two-dimensional virtual presentation of image information at the field location with the captured images and data.

18. The apparatus of claim 17 wherein a video device is utilized to capture panoramic scenes of locations and linear images of routes of the geographical objects, and the captured images replace or supplant files comprising the two-dimensional virtual presentation of image information.

19. A method for generating a two-dimensional virtual presentation of image information using less than all panoramic scenes within a three-dimensional virtual reality space, comprising the steps of:
selecting a first location within the three-dimensional virtual reality space;
storing data relating to a virtual reality panoramic scene at one or more scalar resolutions from the first location;
selecting a second location within the three-dimensional virtual reality space;
storing data relating to a virtual reality panoramic scene at one or more scalar resolutions from the second location;
creating at least one route between the first and second locations, wherein the route entails linear image information at one or more scalar resolutions for movement between the first and second locations;
storing the linear image information of the at least one route; and
generating the two-dimensional virtual presentation of image information based on the selected locations within the three-dimensional virtual reality space and the at least one route connecting the selected locations.

20. The method of claim 19 further comprising the steps of transferring the two-dimensional virtual presentation of image information to a field location, and accessing and viewing the two-dimensional virtual presentation of image information at the field location.

21. The method of claim 20 wherein transferring the two-dimensional virtual presentation of image information to the field location and accessing the two-dimensional virtual presentation of image information at the field location are conducted over a computer network.

22. The method of claim 21 wherein the two-dimensional virtual presentation of image information is stored at one or more application servers on the computer network such that transferring the two-dimensional virtual presentation of image information to the field location and accessing the two-dimensional virtual presentation of image information at the field location are conducted over the computer network via the application servers.

23. The method of claim 22 wherein the two-dimensional virtual presentation of image information is conducted over the Internet.

24. The method of claim 23 wherein the two-dimensional virtual presentation of image information is located and accessed by Uniform Resource Locators (URLs).

25. The method of claim 24 wherein directory information of the two-dimensional virtual presentation of image information, the application servers, and the URLs are automatically generated and updated.

26. The method of claim 25 wherein the directory information is automatically generated and updated via a peer-to-peer protocol.

27. The method of claim 20 wherein transferring the two-dimensional virtual presentation of image information to the field location and accessing the two-dimensional virtual presentation of image information at the field location are accomplished via a removable disk media.

28. The method of claim 20 wherein the three-dimensional virtual reality space is a representation of objects existing in physical reality.

29. The method of claim 28 further comprising the steps of capturing images and data of the objects existing in physical reality, and replacing or supplanting the two-dimensional virtual presentation of image information at the field location with the captured images and data.

30. The method of claim 29 wherein a video device is utilized to capture panoramic scenes of locations and linear images of routes, and the captured images replace or supplant files comprising the two-dimensional virtual presentation of image information.

31. The method of claim 28 further comprising the steps of capturing images and data of the objects existing in physical reality, and overlaying the two-dimensional virtual presentation of image information at the field location with the captured images and data.

32. The method of claim 31 wherein a video device is utilized to capture panoramic scenes of locations and linear images of routes, and the captured images are overlaid on the two-dimensional virtual presentation of image information.

33. The method of claim 28 further comprising the steps of capturing images and data of the objects existing in physical reality, and correcting, updating, and improving information the three-dimensional virtual reality space with the captured images and data.

34. The method of claim 28 wherein the three-dimensional virtual reality space is a representation of geographical objects existing in physical reality.

35. The method of claim 34 further comprising the steps of including Global Positioning System (GPS) information in the three-dimensional virtual reality space and the two-dimensional virtual presentation of image information, locating the geographical objects existing in physical reality using the GPS information, capturing images and data of the geographical objects existing in physical reality using the GPS information, and replacing or supplanting the two-dimensional virtual presentation of image information at the field location with the captured images and data.

36. The method of claim 35 wherein a video device is utilized to capture panoramic scenes of locations and linear images of routes of the geographical objects, and the captured images replace or supplant files comprising the two-dimensional virtual presentation of image information.

37. A system for generating a two-dimensional virtual presentation of image information using less than all panoramic scenes within a three-dimensional virtual reality model, the apparatus comprising:
a central computer;
a virtual reality display device connected to the central computer for displaying a three-dimensional virtual reality model to an operator;
a virtual reality input device connected to the central computer for processing operator input so that the operator can navigate, control, and otherwise interact with the three-dimensional virtual reality model; and
a storage device connected to the central computer for storing data, wherein the central computer processes a command input from the virtual reality input device 1) for selecting a first location within the three-dimensional virtual reality model, 2) for storing data in the storage device relating to a virtual reality panoramic scene at one or more scalar resolutions from the first location, 3) for selecting a second location within the three-dimensional virtual reality model, 4) for storing data in the storage device relating to a virtual reality panoramic scene at one or more scalar resolutions from the second location, 5) for creating at least one route between the first and second locations, wherein the route entails linear image information at one or more scalar resolutions for movement between the first and second locations, 6) for storing the linear image information of the at least one route, and 7) for generating the two-dimensional virtual presentation of image information based on the selected locations within the three-dimensional virtual reality model and the at least one route connecting the selected locations.

38. The apparatus of claim 37 further comprising a field computer for accessing and viewing the two-dimensional virtual presentation of image information at a field location, wherein the two-dimensional virtual presentation of image information is transferred from the central computer to the field computer.

39. The apparatus of claim 38 further comprising a computer used for transferring the two-dimensional virtual presentation of image information to the field computer and for accessing the two-dimensional virtual presentation of image information from the field computer network.

40. The apparatus of claim 39 further comprising one or more application servers on the computer network, wherein the two-dimensional virtual presentation of image information is stored at one or more application servers on the computer network such that transferring the two-dimensional virtual presentation of image information to the field computer and accessing the two-dimensional virtual presentation of image information from the field computer are conducted over the computer network via the application servers.

41. The apparatus of claim 40 wherein the two-dimensional virtual presentation of image information is conducted over the Internet.

42. The apparatus of claim 41 wherein the two-dimensional virtual presentation of image information is located and accessed by Uniform Resource Locators (URLs).

43. The apparatus of claim 42 wherein directory information of the two-dimensional virtual presentation of image information, the application servers, and the URLs are automatically generated and updated.

44. The apparatus of claim 43 wherein the directory information is automatically generated and updated via a peer-to-peer protocol.

45. The apparatus of claim 44 wherein transferring the two-dimensional virtual presentation of image information to the field computer and accessing the two-dimensional virtual presentation of image information from the field computer are accomplished via a removable disk drive and a disk media for the removable disk drive.

46. The apparatus of claim 38 wherein the three-dimensional virtual reality model is a representation of objects existing in physical reality.

47. The apparatus of claim 46 further comprising a device for capturing images and data of the objects existing in physical reality, and a command for replacing or modifying the two-dimensional virtual presentation of image information at the field computer with the captured images and data.

48. The apparatus of claim 47 wherein a video device is utilized to capture panoramic scenes of locations and linear images of routes, and the captured images replace or modify files comprising the two-dimensional virtual presentation of image information.

49. The apparatus of claim 46 further comprising a device for capturing images and data of the objects existing in physical reality, and a command for overlaying the two-dimensional virtual presentation of image information at the field location with the captured images and data.

50. The apparatus of claim 49 wherein a video device is utilized to capture panoramic scenes of locations and linear images of routes, and the captured images are overlaid on the two-dimensional virtual presentation of image information.

51. The apparatus of claim 46 further comprising a device for capturing images and data of the objects existing in physical reality, and a command for correcting, updating, and improving the three-dimensional virtual reality model at the central computer with the captured images and data.

52. The apparatus of claim 46 wherein the three-dimensional virtual reality model is a representation of geographical objects existing in physical reality.

53. The apparatus of claim 52 wherein data containing Global Positioning System (GPS) information are included in the three-dimensional virtual reality model and the two-dimensional virtual presentation of image information, the geographical objects existing in physical reality are located using the GPS information, capturing images and data of the geographical objects existing in physical reality is accomplished using the GPS information, and the two-dimensional virtual presentation of image information at the field computer is replaced or modified with the captured images and data.

54. The apparatus of claim 53 wherein a video device is utilized to capture panoramic scenes of locations and linear images of routes of the geographical objects, and the captured images replace or modify files comprising the two-dimensional virtual presentation of image information.

55. The apparatus of claim 37 wherein the storage device connected to the central computer is a local storage device.

56. The apparatus of claim 55 wherein the local storage device is a local fixed disk drive.

57. The apparatus of claim 55 wherein the local storage device is a local removable disk drive.

58. The apparatus of claim 37 wherein the storage device connected to the central computer is a disk array.

59. The apparatus of claim 58 wherein the disk array is connected to the central computer over a computer network.

60. The apparatus of claim 37 wherein the generated two-dimensional virtual presentation of image information comprises files containing image information and pointers to the next files to be loaded.

61. Computer-executable process steps for generating a two-dimensional virtual presentation of image information using less than all panoramic scenes within a three-dimensional virtual reality space, wherein the process steps are stored on a computer-readable medium, the steps comprising:
a step for selecting a first location within the three-dimensional virtual reality space;
a step for storing data relating to a virtual reality panoramic scene at one or more scalar resolutions from the first location;
a step for selecting a second location within the three-dimensional virtual reality space;
a step for storing data relating to a virtual reality panoramic scene at one or more scalar resolutions from the second location;
a step for creating at least one route between the first and second locations, wherein the route entails linear image information at one or more scalar resolutions for movement between the first and second locations;
a step for storing the linear image information of the at least one route; and
a step for generating the two-dimensional virtual presentation of image information based on the selected locations within the three-dimensional virtual reality space and the at least one route connecting the selected locations.

62. Computer-executable process steps of claim 61 further comprising a step for transferring the two-dimensional virtual presentation of image information to a field location, and a step for accessing and viewing the two-dimensional virtual presentation of image information at the field location.

63. Computer-executable process steps of claim 62 wherein transferring the two-dimensional virtual presentation of image information to the field location and accessing the two-dimensional virtual presentation of image information at the field location are conducted over a computer network.

64. Computer-executable process steps of claim 63 wherein the two-dimensional virtual presentation of image information is stored at one or more application servers on the computer network such that transferring the two-dimensional virtual presentation of image information to the field location and accessing the two-dimensional virtual presentation of image information at the field location are conducted over the computer network via the application servers.

65. Computer-executable process steps of claim 64 wherein the two-dimensional virtual presentation of image information is conducted over the Internet.

66. Computer-executable process steps of claim 65 wherein the two-dimensional virtual presentation of image information is located and accessed by Uniform Resource Locators (URLs).

67. Computer-executable process steps of claim 66 wherein directory information of the two-dimensional virtual presentation of image information, the application servers, and the URLs are automatically generated and updated.

68. Computer-executable process steps of claim 67 wherein the directory information is automatically generated and updated via a peer-to-peer protocol.

69. Computer-executable process steps of claim 62 wherein transferring the two-dimensional virtual presentation of image information to the field location and accessing the two-dimensional virtual presentation of image information at the field location are accomplished via a removable disk media.

70. Computer-executable process steps of claim 62 wherein the three-dimensional virtual reality space is a representation of objects existing in physical reality.

71. Computer-executable process steps of claim 70 further comprising a step for capturing images and data of the objects existing in physical reality, and a step for replacing or supplanting the two-dimensional virtual presentation of image information at the field location with the captured images and data.

72. Computer-executable process steps of claim 71 wherein a video device is utilized to capture panoramic scenes of locations and linear images of routes, and the captured images replace or supplant files comprising the two-dimensional virtual presentation of image information.

73. Computer-executable process steps of claim 70 further comprising a step for capturing images and data of the objects existing in physical reality, and a step for overlaying the two-dimensional virtual presentation of image information at the field location with the captured images and data.

74. Computer-executable process steps of claim 73 wherein a video device is utilized to capture panoramic scenes of locations and linear images of routes, and the captured images are overlaid on the two-dimensional virtual presentation of image information.

75. Computer-executable process steps of claim 70 further comprising a step for capturing images and data of the objects existing in physical reality, and a step for correcting, updating, and improving information in the three-dimensional virtual reality space with the captured images and data.

76. Computer-executable process steps of claim 70 wherein the three-dimensional virtual reality space is a representation of geographical objects existing in physical reality.

77. Computer-executable process steps of claim 76 further comprising a step for including Global Positioning System (GPS) information in the three-dimensional virtual reality space and the two-dimensional virtual presentation of image information, a step for locating the geographical objects existing in physical reality using the GPS information, a step for capturing images and data of the geographical objects existing in physical reality using the GPS information, and a step for replacing or supplanting the two-dimensional virtual presentation of image information at the field location with the captured images and data.

78. Computer-executable process steps of claim 77 wherein a video device is utilized to capture panoramic scenes of locations and linear images of routes of the geographical objects, and the captured images replace or supplant files comprising the two-dimensional virtual presentation of image information.
